(19) United States
(12) Patent Application Publication
(10) Pub. No.: US 2004/0074333 A1
(43) Pub. Date: Apr. 22, 2004

(54) Multifunction operation unit

(75) Inventor: Nobumitsu Kasahara, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/682,867

(22) Filed: Oct. 14, 2003

(30) Foreign Application Priority Data
Oct. 22, 2002 (JP) 2002-306540

(51) Int. Cl. G05G 1/10

(52) U.S. Cl. 74/553

(57) ABSTRACT

A multifunction operation unit includes: an operation unit having an operation shaft projecting from an operation unit main body fixed to the fixing side and capable of making an axial rotation and other operation actions; and a knob secured to the operation shaft for axially rotating or tilting the operation shaft by turning or pressing the operation shaft. The knob is provided with a see-through part that can be seen through in a direction along the operation shaft. A display part is disposed between the see-through part and the operation unit main body and fixed to an audio apparatus main body. Accordingly, the display of the display plate is steady without being rotated or tilted, and seen through the see-through part of the knob, whereby the display is easy to see, preventing an operation error.

The present disclosure relates to the subject matter contained in Japanese Patent Application No. 2002-306540 filed on Oct. 22, 2002, which is incorporated herein by reference in its entirety.

### BACKGROUND OF THE INVENTION

1. Field of the Invention

The present invention relates to a multifunction operation unit.

2. Description of the Related Art

FIGS. 1 and 2 show one example of a multifunction operation unit 100 that is conventionally well known. The multifunction operation unit 100 has an operation unit 103 such as an electronic component having an operation shaft 102 projecting from an operation unit main body 101 and capable of being axially rotated, and a knob 104 fixed to the operation shaft 102.

In the multifunction operation unit 100, the operation unit 103 is axially rotated by turning the knob 104 and reciprocated along the axial direction by pressing the knob 104 in a direction of the rotation shaft 102. And to indicate each function of the operation, a character or figure representing the function is displayed on the surface of the knob 104.

For example, in a case where the multifunction operation unit 100 is employed for an audio apparatus as shown in FIG. 2, the volume is adjusted by turning the knob 104 to axially rotate the operation shaft 102 (see FIGS. 2A and 2B), or an audio medium such as a CD or tape is taken out of the audio apparatus by pressing the knob 104 in the direction of the operation shaft 102 to reciprocate the operation shaft 102 along the axial direction.

As for another conventional example, a multifunction operation unit 110 as shown in FIGS. 3A, 3B, 4A and 4B includes an operation unit 113 having an operation shaft 112 projecting from an operation unit main body 111 and capable of being axially rotated, and a knob 114 fixed to the operation shaft 112 (e.g., see JP-A-8-115641).

In the multifunction operation unit 110, the operation unit 113 is axially rotated by turning the knob 114, or tilted by pressing a peripheral portion on the surface of the knob 114 to tilt the operation shaft back or forth, left or right (up or down, and orthogonal to the paper face as seen in FIGS. 3A and 3B). And a character or figure representing each function of the operation is displayed on the surface of the knob 114.

For example, in a case where the multifunction operation unit 110 is employed for an audio apparatus, as shown in FIGS. 4A and 4B, the operation shaft 112 is axially rotated by turning the knob 114, or the operation shaft 112 is tilted in any direction, back or forth, left or right via the knob 114 (see FIG. 3B). That is, the volume is adjusted by turning the knob 114, and the volume balance of a plurality of speakers arranged around the listener is adjusted by tilting the operation shaft 112 via the knob 114.

In the prior art, since the character or figure indicating each function of the operation is displayed on the surface of the knobs 104 and 114, if the knobs 104 and 114 is turned, the character or figure is tilted or reversed, resulting in a problem that the character or figure is difficult to see and has a bad appearance, as shown in FIG. 2B and FIG. 4B.

Therefore, the function of the multifunction operation unit 100, 110 may be written on the fixing side 120 where the multifunction operation units 100 and 110 is fixed, as shown in FIG. 5, but not on the surface of the knobs 104 and 114.

However, in the case described above, the display of the function of the operation is located away from the knobs 104 and 114, resulting in a problem that the operation of the knobs 104 and 114 is difficult to recognize.

### SUMMARY OF THE INVENTION

It is therefore an object of the invention to provide a multifunction operation unit with an improved way of displaying a function of the operation of the multifunction operation unit by solving the problems associated with the prior art described above.

In order to achieve the object, according to one aspect of the invention, there is provided a multifunction operation unit used in a state attached to a main body of an apparatus, the multifunction operation unit including: an operation unit main body configured to be attached to the main body of the apparatus; an operation shaft projected from the operation unit main body and configured to operate an axial rotation operation and at least one of a tilting operation and a reciprocating operation along an axial direction thereof; a knob attached to one end of the shaft; a see-through part provided on the knob and configured to be capable of seeing through in a direction along the operation shaft; and a display part disposed between the see-through part and the operation unit main body and configured to be fixed to the main body of the apparatus.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a cross-sectional view showing one example of a conventional multifunction operation unit;

FIG. 2A is a plan view showing a conventional knob indication before rotation and FIG. 2B is a plan view showing the conventional knob indication after rotation;

FIG. 3A is a side view showing a state where an operation shaft is not tilted and FIG. 3B is a conventional side view showing a state where the operation shaft is tilted;

FIG. 4A is a plan view showing a display part before rotation and FIG. 4B is a conventional plan view showing a display plate when the operation shaft is rotated;

FIG. 5 is a conventional plan view showing the display part provided at a position apart from the knob;

FIG. 6A is a cross-sectional view showing a first example of the multifunction operation unit according to the present invention and FIGS. 6B and 6C are plan views thereof;

FIG. 7A is a plan view of the knob, FIG. 7B is a cross-sectional view and FIG. 7C is a side view;

FIG. 8A is a plan view of a display plate, FIG. 8B is a cross-sectional view and FIG. 8C is a side view;

FIG. 9A is a cross-sectional view showing a second example of the multifunction operation unit according to the invention and FIGS. 9B and 9C are plan views thereof;

FIG. 10 is a cross-sectional view showing a third example of the multifunction operation unit according to the invention;

FIG. 11 is a flowchart for illuminating the display part in accordance with the operation mode; and

FIG. 12 is a cross-sectional view showing a fourth example of the multifunction operation unit according to the invention.

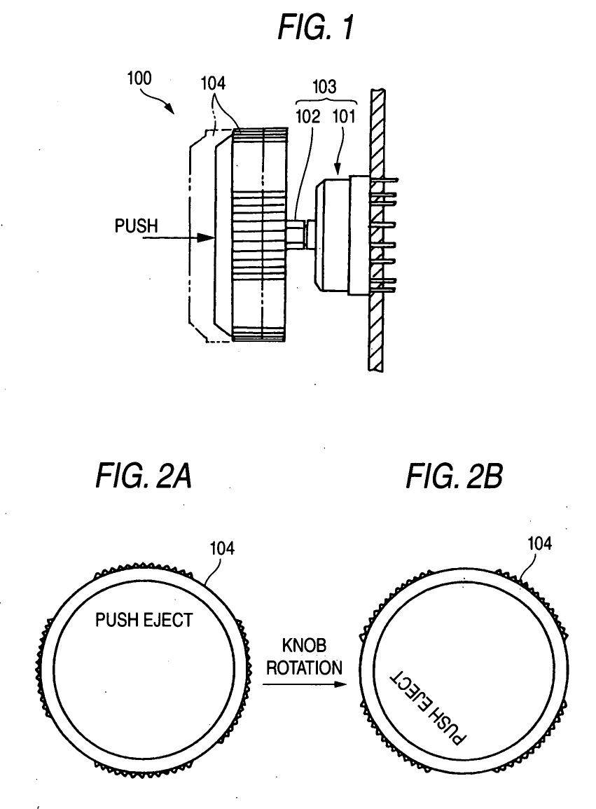

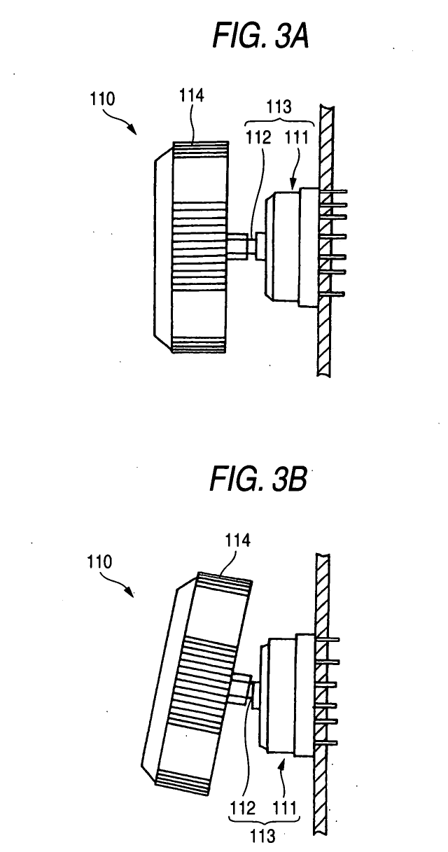

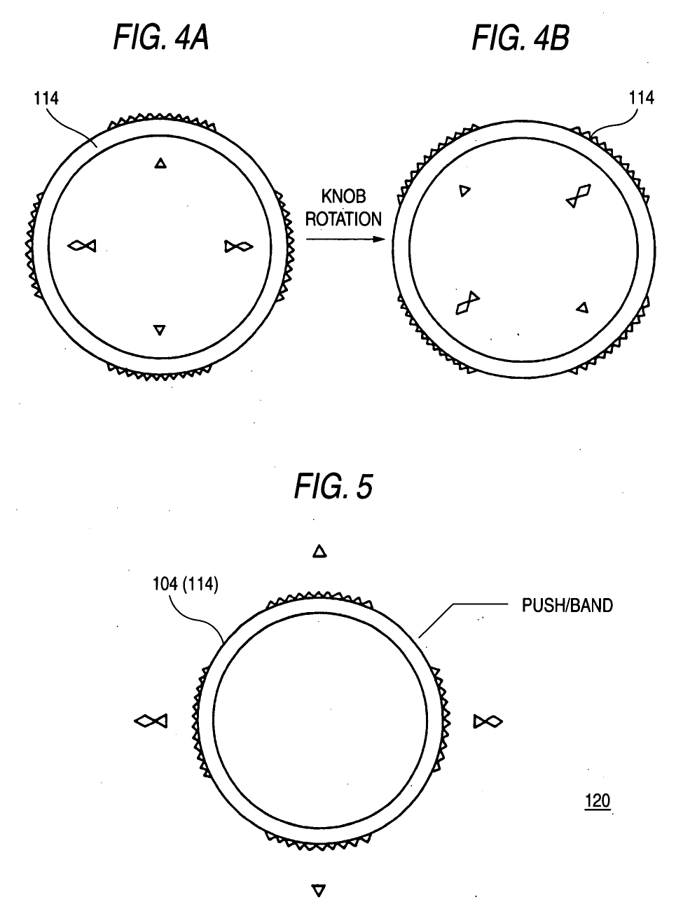

### DETAILED DESCRIPTION OF THE PREFERRED EMBODIMENTS

The preferred embodiments of the invention will be described below with reference to the accompanying drawings. A multifunction operation unit has an operation unit main body fixed to the fixing side (a side where attached to a main body of an apparatus) and an operation shaft projecting from the operation unit main body. A knob is attached on the operation shaft. The operation shaft can be axially rotated around the shaft center, in which other operation actions including reciprocating the shaft in the axial direction and tilting the shaft are possible. That is, the operation shaft is axially rotated by turning the knob attached on the operation shaft to operate the operation unit main body and at the same time pressed or tilted via the knob to operate the operation unit main body.

The knob is provided with a see-through part for seeing the knob through the see-through part. Between the see-through part and the operation unit main body, a display part is provided to indicate an operation action of the operation shaft. The display part is attached on the fixing side where the operation unit main body is fixed.

That is, the display part is fixed to the operation unit main body, or directly on the fixing side. The display part is illuminated to be easily seen. The display itself may be illuminated up or made luminous, or illuminated.

The display or non-display of the display part may be selected in accordance with an operation mode of the operation unit, if needed.

Accordingly, in operating the operation shaft via the knob to operate the operation unit main body, the user can operate the knob while seeing the content of the display on the display part through the see-through part of the knob. Since the display part is fixed to the fixing side, it is not rotated by turning the knob to axially rotate the operation shaft, and attached in a steady state at any time. Therefore, the user can accurately grasp the content of the display to operate the operation unit main body.

A multifunction operation unit according to a first embodiment of the invention will be described below.

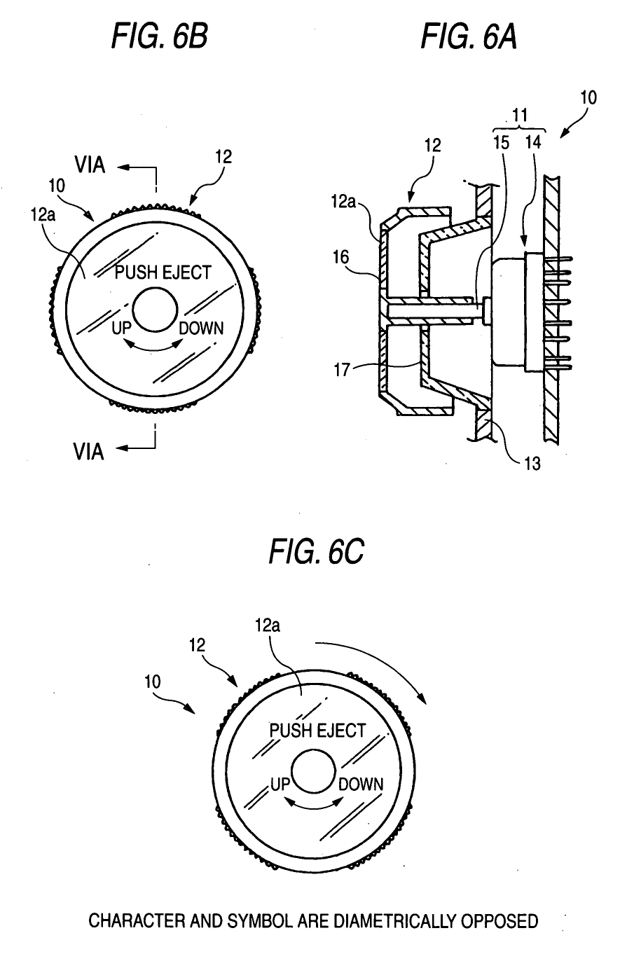

The multifunction operation unit 10 as shown in FIG. 6 includes a volume switch 11 as the operation unit useful for an audio apparatus, and a knob 12 for operating the volume switch 11.

The volume switch 11 has an operation unit main body 14 fixed to an audio apparatus main body 13 that is on the fixing side and an operation shaft 15 projecting from the operation unit main body 14. The knob 12 is attached to the operation shaft 15, in which it can be axially rotated around the shaft center, and reciprocated along an axial direction.

That is, the volume is adjusted by turning the knob 12 to axially rotate the operation shaft 15. By pressing the knob 12 in the axial direction, other operation actions can be conducted, such as ejecting a optical disk (e.g. CD, DVD) or an audio tape from the audio apparatus, and turning on or off the power of the audio apparatus.

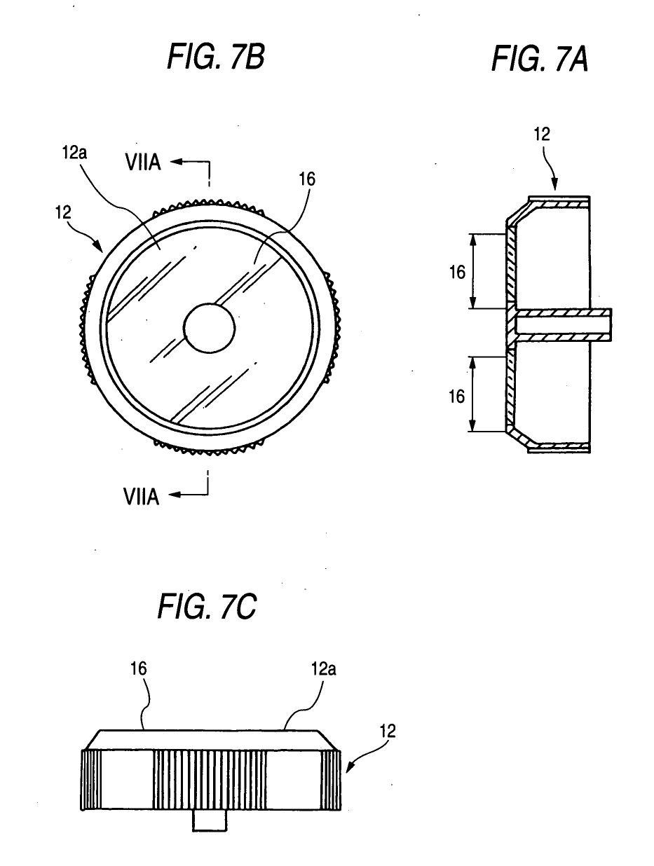

As shown in FIG. 7, a see-through part 16 that can be seen through in a direction along the operation shaft 15 is provided on a part or all of the knob 12.

One example to provide the see-through part 16 is to form a top portion 12a of the knob 12 with a transparent or translucent member (including member that are colored), to thereby configure to see through the knob 12. Another example to provide the see-through part 16 is to provide an opening portion on the top portion 12a of the knob 12 to see through the knob 12.

As shown in FIG. 6A, a display plate 17 indicating the operation content of the knob 12 as the display part is provided between the knob 12 and the operation unit main body 14.

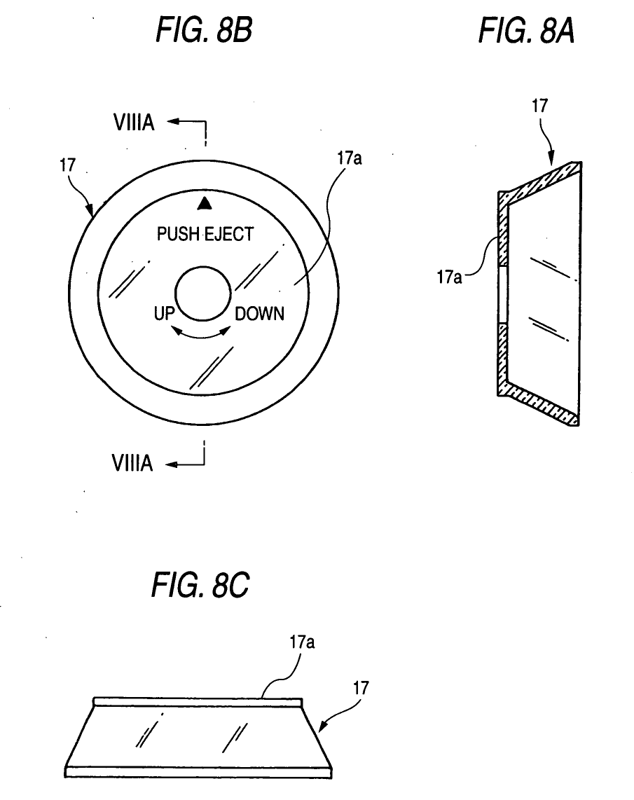

The display plate 17 is fixed to the audio apparatus main body 13 or the operation unit main body 14, and not rotated by turning the knob 12, as shown in FIGS. 6B and 6C. Also, a character or figure representing the function of the each operation is displayed on a surface 17a of the display plate 17, as shown in FIG. 8.

In operating the volume switch 11, the volume is adjusted by turning the knob 12. After listening, the optical disk or the audio tape is ejected by pressing the knob 12 in the axial direction.

At this time, the character or figure displayed on the display plate 17 is seen through the see-through part 16 of the knob 12, whereby the user can operate the knob 12 while seeing the display on the display plate 17, for example, indicating the direction for turning the knob 12 or ejecting the optical disk or the audio tape by pressing the knob 12 in the axial direction.

Accordingly, the display plate 17 is fixed to the fixing side of the audio apparatus main body 13, and the display of the display plate 17 is kept unchanged and steady by turning the knob 12, whereby the display indicating other operation actions is easy to see, preventing an operation error.

A multifunction operation unit according to a second embodiment of the invention will be described below with reference to the drawings. Parts the same as those in the first embodiment are denoted by the same reference numerals as those in the first embodiment, so that detailed description of the parts will be omitted here.

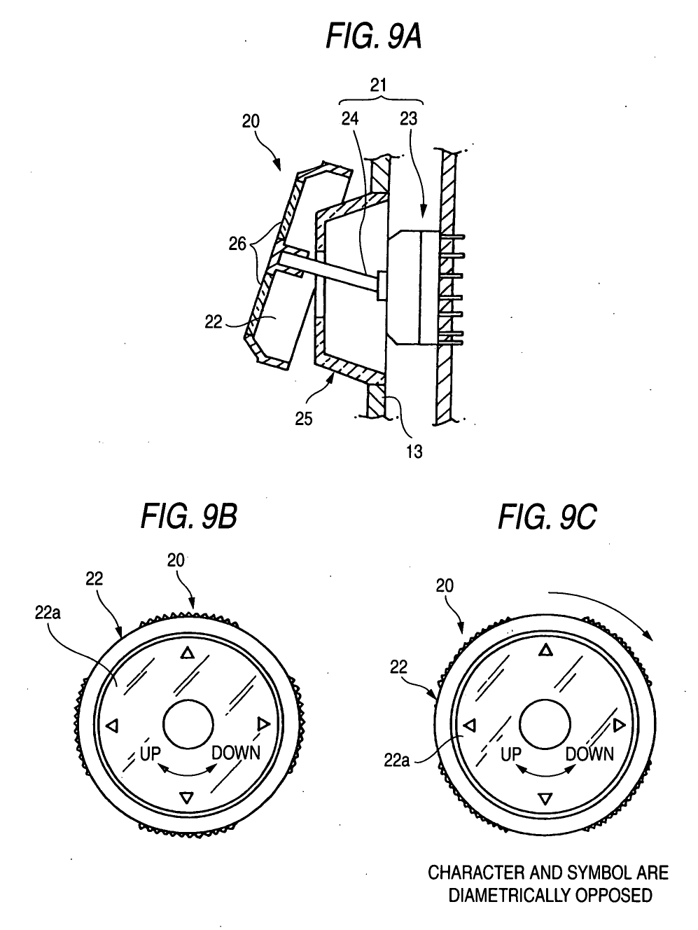

The multifunction operation unit 20 as shown in FIG. 9 has a joy stick 21 as an electronic component for adjusting the volume balance of a plurality of speakers disposed around the listener for example, in the audio apparatus or adjusting the volume by turning a knob 22, and the knob 22 for operating the joy stick 21.

The joy stick 21 has an operation unit main body 23 fixed to the audio apparatus main body 13 that is on the fixing side and an operation shaft 24 projecting from the operation unit main body 23. The knob 22 is attached to the operation shaft 24, which can be axially rotated around the shaft center. The operation shaft 24 can be tilted in any direction.

That is, the volume is adjusted by turning the knob 22 to axially rotate the operation shaft 24. The volume balance of the speakers is adjusted by pressing a peripheral portion on the surface of the knob 22 to tilt the operation shaft 24 back or forth, left or right.

A display plate 25 as the display part indicating the operation content of the knob 22 is provided between the knob 22 and the operation unit main body 23. The display plate 25 is fixed to the audio apparatus main body 13 or the operation unit main body 23 of the joy stick 21, and not rotated or tilted by turning the knob 22 or tilting the operation shaft 24.

Also, a transparent see-through part 26 is provided in a part or all of the knob 22 to see the display plate 25 through the knob 22.

Accordingly, the volume is adjusted by turning the knob 22 in operating the joy stick 21. And the volume balance of the speakers is adjusted by pressing a peripheral portion on the surface of the knob 22 to tilt the operation shaft 24 back or forth, left or right.

At this time, a character or figure displayed on the display plate 25 is seen through the see-through part 26 of for example the knob 22, whereby the user can adjust the volume by turning the knob 22 or the volume balance by moving the knob 22 back or forth, left or right to tilt the operation shaft 24 by referring to the display of the display plate 25.

Accordingly, the display plate 25 is fixed to the fixing side of the audio apparatus main body 13, and the display of the display plate 25 is kept unchanged and steady by turning the knob 12, whereby the display indicating other operation actions is easy to see, preventing an operation error.

A multifunction operation unit according to a third embodiment of the invention will be described below with reference to the drawings. Parts the same as those in the first or the second embodiment are denoted by the same reference numerals as those in the first embodiment, so that detailed description of the parts will be omitted here.

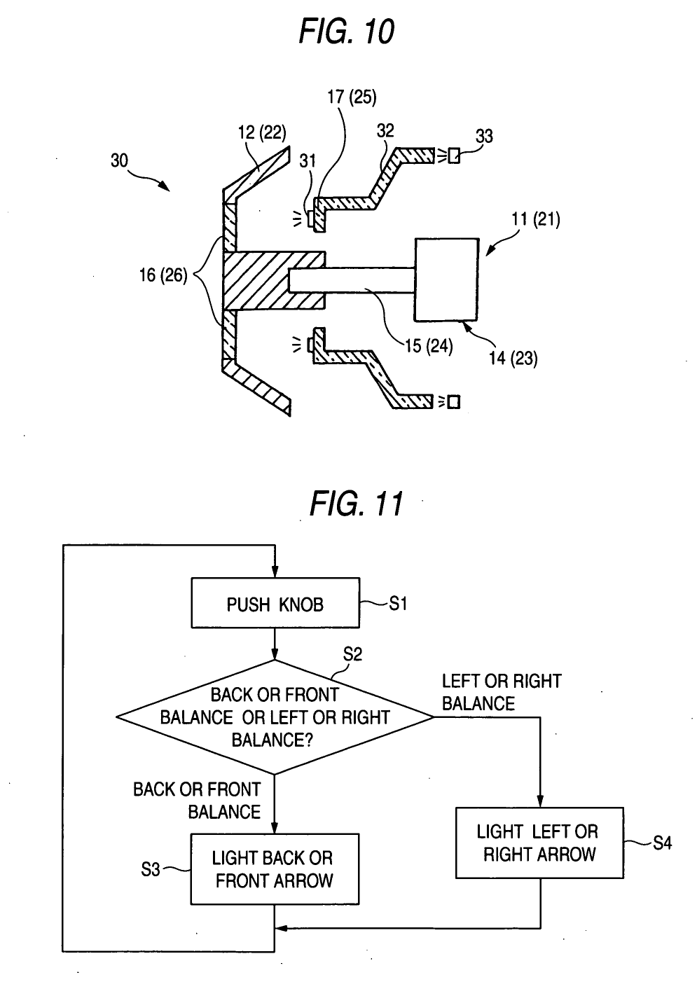

The multifunction operation unit 30 as shown in FIG. 10 is applicable to the multifunction operation units 10 and 20 of the first and the second embodiments as described previously and shown in FIGS. 6A, 6B, 6C, 9A, 9B and 9C, and has a particular characteristic in the display part.

In the following, an example in which the multifunction operation unit 30 is applied to the multifunction operation unit 20 according to the second embodiment will be given. In the display part of the third embodiment, a display portion 31 is formed of a transparent member, and disposed opposite to the see-through part 26 of the knob 22.

And light conducting member 32 also serving as the display plate conducts a light emitted from a light emitting part 33 such as an LED to illuminate the display portion 31. In the embodiment, the light conducting member 32 and the LED is provided as an illumination unit. Alternatively, the display portion for a display character or figure may be formed by an illuminant such as an LED and bonded with the display plate 25 to illuminate directly.

The display portion 31 may be attached to the audio apparatus main body 13 that is on the fixing side or the operation unit main body 23 of the joy stick 21 that is an electronic component independently without providing the display plate 25.

As for illuminating of the display portion 31, the display/non-display of the display part can be selected in accordance with an operation mode. That is, in the multifunction operation unit 20 as shown for example in FIG. 9, the operation mode can be switched by pressing the knob 22 to push in the operation shaft 24 along the axial direction, whereby the operation content corresponding to the operation mode is only displayed on the display portion 31.

For example, the knob 22 is pressed to select the operation mode (step S1), and when in a back or forth volume balance adjusting mode (step S2), a back or forth arrow in the display portion 31 is only illuminated (step S3) to adjust the back or forth volume balance by reciprocating the knob 22 along the axial direction, as shown in FIG. 11.

Also, when in a left or right volume balance adjusting mode by reciprocating the knob 22 along the axial direction (step S2), a left or right arrow in the display portion 31 is only illuminated (step S4), and the left or right volume balance is adjusted by pressing a left or right peripheral portion on the surface of the knob 22 to tilt the operation shaft left or right.

Accordingly, since the display portion 31 is illuminated, the multifunction operation unit 30 can be operated clearly seeing the display portion 31 even when the multifunction operation unit 30 is attached in the dark place.

Also, the display portion 31 corresponding to the operation mode is only illuminated, preventing an operation error.

The process of steps S2, S3 and S4 is made by a display control unit (not shown) provided in the multifunction operation unit 30. The display control unit may be provided as an independent unit separate from the multifunction operation unit 30.

A multifunction operation unit according to a fourth embodiment of the invention will be described below with reference to the drawings. Parts the same as those in the first through third embodiments are denoted by the same reference numerals as those in the first embodiment, so that detailed description of the parts will be omitted here.

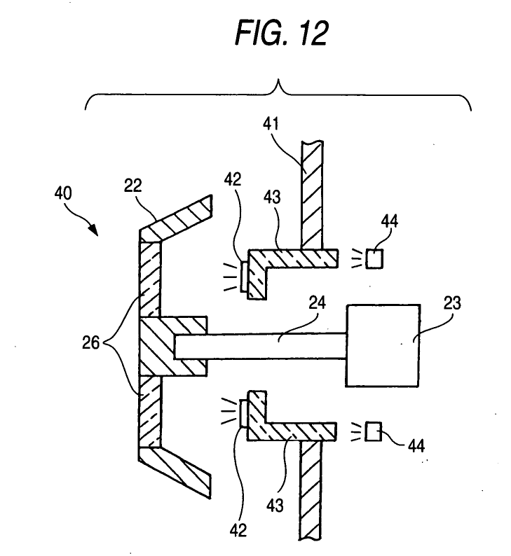

The multifunction operation unit 40 as shown in FIG. 12 is applicable to the multifunction operation units 10 and 20 of the first and the second embodiments as described previously and shown in FIGS. 6A, 6B, 6C, 9A, 9B and 9C, in which a display portion 42 is provided at a position corresponding to the see-through part 26 of the knob 22 over a panel 41 covering an electronic component. In the following, an example in which the multifunction operation unit 40 is applied to the multifunction operation unit 20 according to the second embodiment will be given.

The display portion 42 is connected to a light emitting part 44 by light conducting member 43 attached on the panel 41, and lighted by causing the light emitting part 44 to emit the light. The display portion 42 itself may be made of an illuminant member, and attached on the panel 41 to directly illuminate the display portion 42.

Accordingly, the display portion 42 is provided on the panel 41 covering the joy stick 21 that is an electronic component, whereby there is no need for providing any other member such as the display plate 25, and the number of parts is reduced.

Also, when the multifunction operation unit 41 is attached to the audio apparatus main body 13 that is on the fixing side, it is easily treated.

Moreover, in a case where the panel 41, the display portion 42 and the light conducting member 43 are integrally formed, the number of parts is reduced.

As described above, the aforementioned multifunction operation units 10, 20, 30 and 40 according to the invention include the operation unit 11, 21 having the operation shaft 15, 24 projecting from the operation unit main body 14, 23 fixed to the audio apparatus main body 13 that is on the fixing side and allowing for the axial rotation and other operation actions, and the knob 12, 22 fixed to the operation shaft 15, 24 for operating the operation unit 11, 21.

And the knob 12, 22 is provided with the see-through part 16, 26 that can be seen through in the direction along the operation shaft 15, 24, and the display plate 17, 25 fixed to the fixing side of the audio apparatus main body 13 is provided between the see-through part 16, 26 and the operation unit main body 14, 23.

Accordingly, the display of the display plate 17, 25 is fixed not to be rotated or tilted by turning the knob 12, 22, and can be seen through the see-through part 16, 26 of the knob 12, 22, whereby the display is easy to see, preventing an operation error.

The multifunction operation units 10, 20, 30 and 40 of the invention are not limited to the embodiments as above described, but various modifications or variations may be adequately made thereto.

For example, in the above embodiments, other operation actions by the operation shaft 15, 24 include pressing the operation shaft 24 in the axial direction and tilting the operation shaft 24, but other operation actions may be further considered.

Although the present invention has been shown and described with reference to a specific preferred embodiment, various changes and modifications will be apparent to those skilled in the art from the teachings herein. Such changes and modifications as are obvious are deemed to come within the spirit, scope and contemplation of the invention as defined in the appended claims.

What is claimed is:

1. A multifunction operation unit used in a state attached to a main body of an apparatus, the multifunction operation unit comprising:
an operation unit main body configured to be attached to the main body of the apparatus;
an operation shaft projected from the operation unit main body and configured to operate an axial rotation operation and at least one of a tilting operation and a reciprocating operation along an axial direction thereof;
a knob attached to one end of the shaft;
a see-through part provided on the knob and configured to be capable of seeing through in a direction along the operation shaft; and
a display part disposed between the see-through part and the operation unit main body and configured to be fixed to the main body of the apparatus.

2. The multifunction operation unit as claimed in claim 1, wherein the see-through part comprises at least one of a transparent member and a translucent member provided on a top portion of the knob.

3. The multifunction operation unit as claimed in claim 1, wherein the see-through part comprises an opening portion provided on a top portion of the knob.

4. The multifunction operation unit as claimed in claim 1 further comprising an illumination unit configured to illuminate the display part.

5. The multifunction operation unit as claimed in claim 4, wherein the illumination unit comprises a light emitting member configured to emit light and a light conducting member configured to conduct the light emitted by the light emitting member to the display part.

6. The multifunction operation unit as claimed in claim 1, wherein the display part comprises a panel configured to cover the operation unit main body and the operation shaft.

7. The multifunction operation unit as claimed in claim 1 further comprises a display control unit configured to control the display and non-display of the display part in accordance with an operation mode of the operation unit main body and the operation shaft.
